(19) United States
(12) Patent Application Publication
(10) Pub. No.: US 2025/0031146 A1
(43) Pub. Date: Jan. 23, 2025

(54) SIGNALING AND UE BEHAVIOR FOR SIDELINK PRS DRX CONFIGURATION IN NR SIDELINK POSITIONING

(71) Applicant: QUALCOMM Incorporated, San Diego, CA (US)

(72) Inventors: Alexandros MANOLAKOS, Athens, Attikí (GR); Mukesh KUMAR, Hyderabad, Punjab (IN); Seyedkianoush HOSSEINI, San Diego, CA (US); Srinivas YERRAMALLI, San Diego, CA (US)

(21) Appl. No.: 18/714,497

(22) PCT Filed: Dec. 16, 2022
(86) PCT No.: PCT/US2022/081784

§ 371 Date: May 29, 2024

(30) Foreign Application Priority Data
Feb. 4, 2022 (GR) 20220100115

(51) Int. Cl. H04W 52/02; H04L 5/00; H04W 24/08; H04W 72/40; H04W 76/28

(52) U.S. Cl. CPC H04W 52/0216; H04L 5/0051; H04W 24/08; H04W 72/40; H04W 76/28

(57) ABSTRACT

In some implementations, a first UE may receive an indication of the positioning session in which the first UE is to participate, wherein the first UE is to participate by sending and/or receiving SL-PRS via an SL communication link with a second UE. The first UE may obtain, with the first UE, the SL PRS DRX configuration for the positioning session, wherein: the SL PRS DRX configuration for the positioning session designates a plurality of DRX cycles during the positioning session, each DRX cycle having a respective ON duration and a respective OFF duration. The first UE may monitor the SL communication link for the positioning information with the first UE in accordance with the SL PRS DRX configuration.

### BACKGROUND

### 1. Field of Disclosure

The present disclosure relates generally to the field of wireless communications, and more specifically to determining the location of a User Equipment (UE) using radio frequency (RF) signals.

### 2. Description of Related Art

In a data communication network, various positioning techniques can be used to determine the position of a mobile device (referred to herein as a UE). Some of these positioning techniques may involve determining distance and/or angular information of RF signals received by one or more other UEs communicatively coupled with the data communication network. In a fifth generation (5G) wireless standard, referred to as New Radio (NR), direct communication between UEs (including the transmission of RF signals for positioning) may be referred to as sidelink (also referred to herein as “SL”). For power savings, UEs may engage in discontinuous reception (DRX) operation during which UEs may be unavailable for receiving control information via a sidelink connection during certain period of time. This can complicate the coordination and execution of positioning using sidelink.

### BRIEF SUMMARY

Embodiments herein provide for the use of a specialized discontinuous reception (DRX) among UEs participating in a positioning session. This SL DRX for positioning (also referred to herein as an SL positioning reference signal (PRS) DRX) may be associated with a resource pool for positioning (RP-P), PRS configuration, or specific positioning session, and may be used to allow efficient bandwidth usage by enabling the multicast of SL PRS from a one UE to multiple UEs.

An example method of implementing a sidelink positioning reference signal (SL-PRS) discontinuous reception (DRX) configuration for a positioning session at a first user equipment (UE), according to this disclosure, may comprise receiving, at the first UE, an indication of the positioning session in which the first UE is to participate, wherein the first UE is to participate by sending and/or receiving SL-PRS via a sidelink (SL) communication link with a second UE. The method also may comprise obtaining, with the first UE, the SL PRS DRX configuration for the positioning session, wherein: the SL PRS DRX configuration for the positioning session designates a plurality of DRX cycles during the positioning session, each DRX cycle having a respective ON duration and a respective OFF duration; during each ON duration, the first UE is configured to monitor the SL communication link for positioning information, the positioning information comprising sidelink control information (SCI), the SL-PRS, or both; and during each OFF duration, the first UE is configured not to monitor the SL communication link for the positioning information. The method also may comprise monitoring the SL communication link for the positioning information with the first UE in accordance with the SL PRS DRX configuration.

An example first user equipment (UE) for implementing a sidelink positioning reference signal (SL-PRS) discontinuous reception (DRX) configuration for a positioning session, according to this disclosure, may comprise a transceiver, a memory, one or more processors communicatively coupled with the transceiver and the memory, wherein the one or more processors are configured to receive, via the transceiver, an indication of the positioning session in which the first UE is to participate, wherein the first UE is to participate by sending and/or receiving SL-PRS via a sidelink (SL) communication link with a second UE. The one or more processors further may be configured to obtain, via the transceiver, the SL PRS DRX configuration for the positioning session, wherein: the SL PRS DRX configuration for the positioning session designates a plurality of DRX cycles during the positioning session, each DRX cycle having a respective ON duration and a respective OFF duration; and during each ON duration, the first UE is configured to monitor the SL communication link for positioning information, the positioning information comprising sidelink control information (SCI), the SL-PRS, or both; during each OFF duration, the first UE is configured not to monitor the SL communication link for the positioning information. The one or more processors further may be configured to monitor the SL communication link for the positioning information with the first UE in accordance with the SL PRS DRX configuration.

An example apparatus for implementing a sidelink positioning reference signal (SL-PRS) discontinuous reception (DRX) configuration for a positioning session at a first user equipment (UE), according to this disclosure, may comprise means for receiving an indication of the positioning session in which the first UE is to participate, wherein the first UE is to participate by sending and/or receiving SL-PRS via a sidelink (SL) communication link with a second UE. The apparatus further may comprise means for obtaining the SL PRS DRX configuration for the positioning session, wherein: the SL PRS DRX configuration for the positioning session designates a plurality of DRX cycles during the positioning session, each DRX cycle having a respective ON duration and a respective OFF duration; during each ON duration, the first UE is configured to monitor the SL communication link for positioning information, the positioning information comprising sidelink control information (SCI), the SL-PRS, or both; and during each OFF duration, the first UE is configured not to monitor the SL communication link for the positioning information. The apparatus further may comprise means for monitoring the SL communication link for the positioning information with the first UE in accordance with the SL PRS DRX configuration.

According to this disclosure, an example non-transitory computer-readable medium stores instructions for implementing a sidelink positioning reference signal (SL-PRS) discontinuous reception (DRX) configuration for a positioning session at a first user equipment (UE), the instructions comprising code for receiving, at the first UE, an indication of the positioning session in which the first UE is to participate, wherein the first UE is to participate by sending and/or receiving SL-PRS via a sidelink (SL) communication link with a second UE. The instructions further may comprise code for obtaining, with the first UE, the SL PRS DRX configuration for the positioning session, wherein: the SL PRS DRX configuration for the positioning session designates a plurality of DRX cycles during the positioning session, each DRX cycle having a respective ON duration and a respective OFF duration; during each ON duration, the first UE is configured to monitor the SL communication link for positioning information, the positioning information comprising sidelink control information (SCI), the SL-PRS, or both; and during each OFF duration, the first UE is configured not to monitor the SL communication link for the positioning information. The instructions further may comprise code for monitoring the SL communication link for the positioning information with the first UE in accordance with the SL PRS DRX configuration.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3A-3C are simplified diagrams of scenarios in which sidelink positioning may be used to determine the position of a target user equipment (UE).

FIG. 4A-4C diagrams illustrating how discontinuous reception (DRX) may be implemented, according to embodiments.

FIG. 5 is a graph illustrating how DRX may be used in a unicast sidelink (SL) configuration, according to an embodiment.

FIG. 6 is an illustration of an example scenario in which DRX may be used to obtain additional anchor points for positioning a target UE.

FIG. 7 is a call flow diagram illustrating an example of how an SL-DRX positioning configuration may be used in the scenario of FIG. 6.

FIG. 8 is a flow diagram of implementing an SL PRS DRX configuration for a positioning session, according to an embodiment, according to an embodiment.

FIG. 9 is a block diagram of an embodiment of a UE, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

As previously indicated, positioning of a UE may be complicated one or more UEs participating in the positioning session operate under a discontinuous reception (DRX) configuration during which UEs may be unavailable for receiving control information via a sidelink connection during certain period of time. Because SL between each pair of UEs may have a different DRX configuration, this can complicate the coordination and execution of positioning using sidelink. Embodiments address these and other issues by providing for the use of a SL DRX for positioning (or SL PRS DRX). Additional details regarding the embodiments will be described after a discussion of positioning technologies and applications.

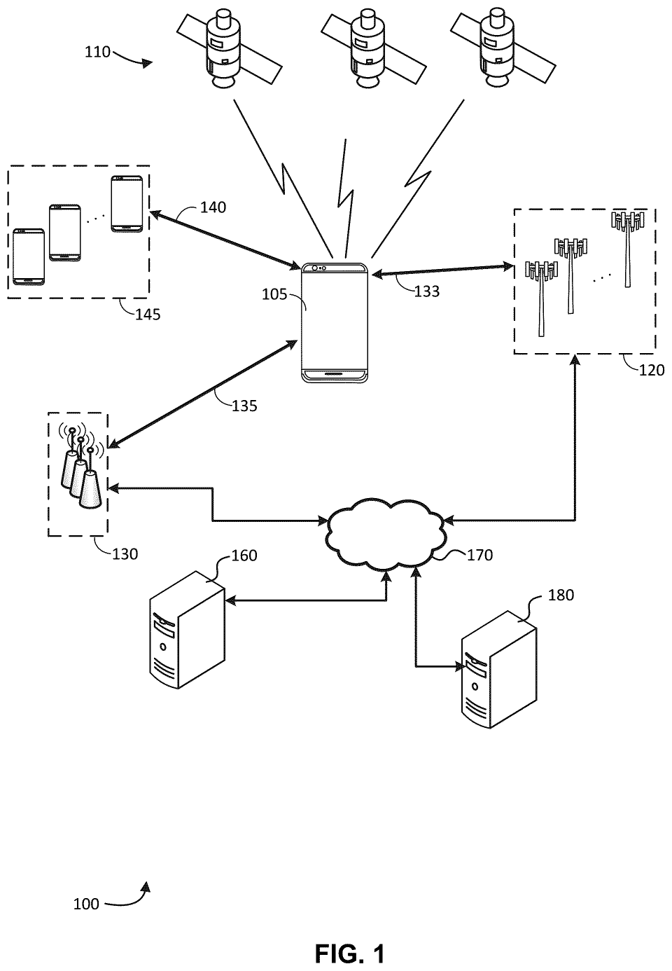

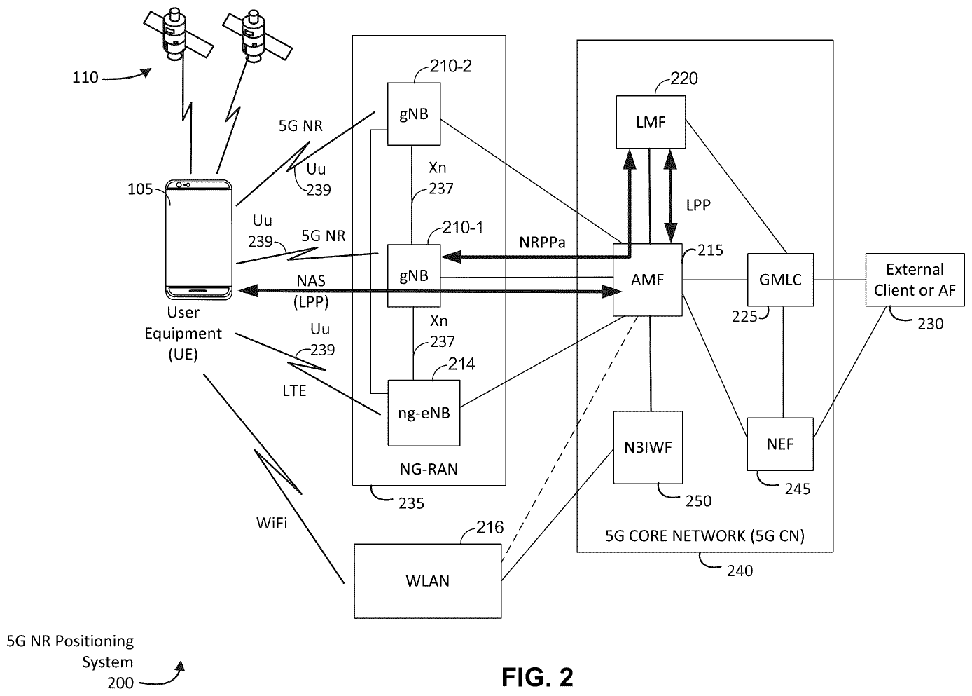

FIG. 1 is a simplified illustration of a positioning system 100 in which a UE 105, location server 160, and/or other components of the positioning system 100 can use the techniques provided herein (and other positioning techniques) for positioning the UE 105, according to an embodiment. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station” in reference to physical transmission points (e.g., for UE positioning). In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When one or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of another UE 145 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes, which may include NR NodeB (gNB) 210-1 and 210-2 (collectively and generically referred to herein as gNBs 210), ng-eNB 214, and/or WLAN 216 to implement one or more positioning methods. The gNBs 210 and/or the ng-eNB 214 may correspond with base stations 120 of FIG. 1, and the WLAN 216 may correspond with one or more access points 130 of FIG. 1. Optionally, the 5G NR positioning system 200 additionally may be configured to determine the location of a UE 105 by using an LMF 220 (which may correspond with location server 160) to implement the one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

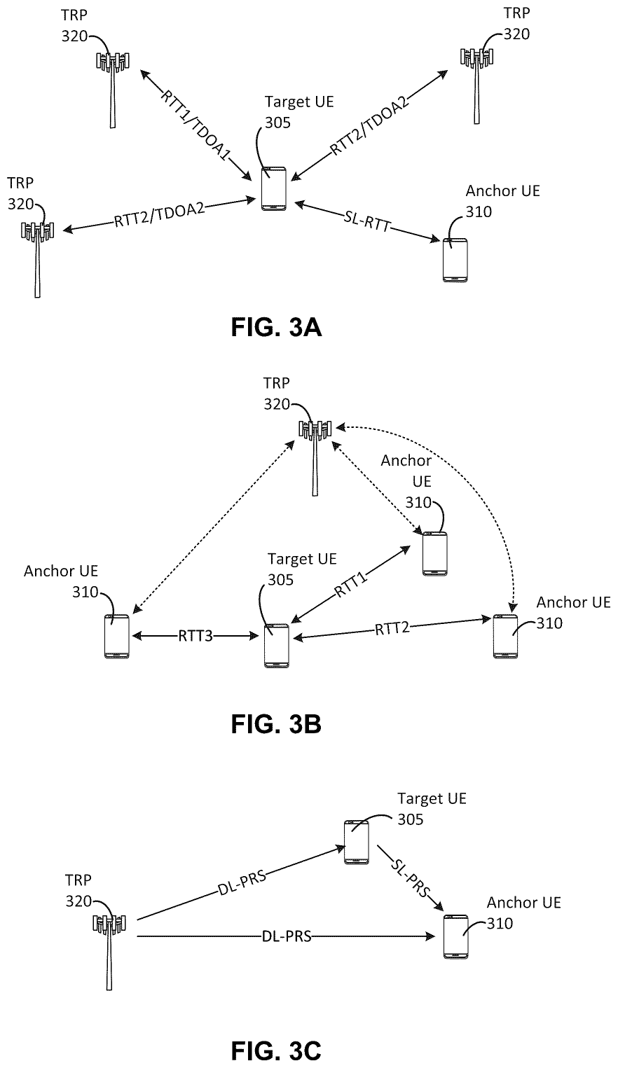

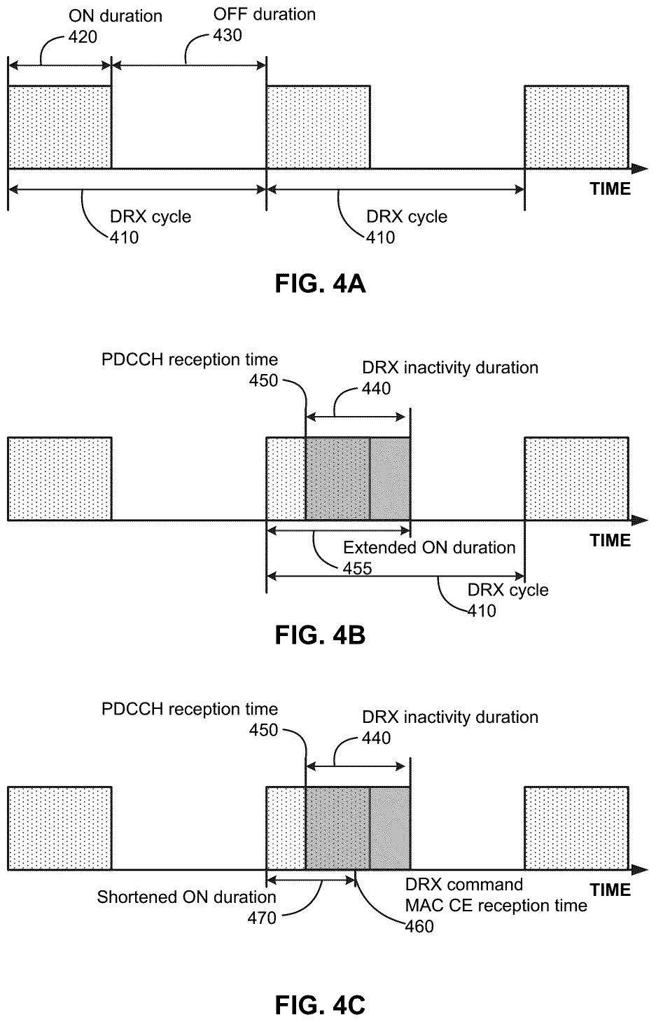

FIGS. 3A-3C are simplified diagrams of scenarios in which sidelink positioning may be used to determine the position of a target UE 305 (e.g., within the systems shown in FIGS. 1 and 2), according to some embodiments. Further, one or more UEs may perform DRX operation, as discussed hereafter with regard to FIGS. 4A-4C. In FIGS. 3A-3C, one or more anchor UEs 310 may be used to send and/or receive reference signals via sidelink. As illustrated, positioning may be further determined using one or more TRPs 320 (base stations) via respective Uu interfaces. It will be understood, however, that the signals used for positioning of the UE 305 may vary, depending on desired functionality. More particularly, some types of positioning may utilize signals other than RTT/TDOA as illustrated in FIGS. 3A-3C.

The diagram of FIG. 3A illustrates a configuration in which the positioning of a target UE 305 may comprise RTT and/or TDOA measurements between the target UE 305 and three TRPs 320. In this configuration, the target UE 305 may be in coverage range for DL and/or UL signals via Uu connections with the TRPs 320. Additionally, the anchor UE 310 at a known location may be used to improve the position determination for the target UE 305 by providing an additional anchor. As illustrated, ranging may be performed between the target UE 305 and anchor UE 310 by taking RTT measurements via the sidelink connection between the target UE 305 and anchor UE 310.

The diagram of FIG. 3B illustrates a configuration in which the positioning of a target UE 305 may sidelink only (SL-only) positioning/ranging. In this configuration, the target UE 305 may perform RTT measurements via sidelink connections between a plurality of anchor UEs 310. In this example, the target UE 305 may not be in UL coverage of the TRP 320, and therefore each anchor UE 310 may report RTT measurement information to the network of via a Uu connection between each anchor UE 310 and the TRP 320. (In cases in which a UE relays information between a remote UE and a TRP, a UE may be referred to as a “relay” UE.) Such scenarios may exist when the target UE 305 has weaker transmission power than anchor UEs 310 (e.g., the target UE 305 comprises a wearable device, and anchor UEs comprise larger cellular phones, IoT devices, etc.). In other scenarios in which the target UE 305 is within UL coverage of the TRP 320, the target UE 305 may report RTT measurements directly to the TRP 320. In some embodiments, no TRP 320 may be used, in which case one of the UEs (e.g., the target UE 305 or one of the anchor UEs 310) may receive RTT measurement information and determine the position of the target UE 305.

The diagram of FIG. 3C illustrates a configuration in which the positioning of a target UE 305 may comprise the target UE 305 and anchor UE 310 receiving a reference signal (DL-PRS) from the TRP 320, and the target UE 305 sending a reference signal (SL-PRS) to the anchor UE 310. The positioning of the target UE can be determined based on known positions of the TRP 320 and anchor UE 310 and a time difference between a time at which the anchor UE 310 receiving the reference signal from the TRP 320 and a time at which the anchor UE 310 receives the reference signal from the target UE 305.

As previously discussed, the use of sidelink positioning (e.g., SL-only or Uu/SL positioning, as illustrated in FIGS. 3A-3C) may utilize RP-P. RP-P may be conveyed to UEs via a sidelink configuration (e.g., using techniques described hereafter), and may designate particular resource pools for sidelink reference signals in different scenarios. Resource pools comprise a set of resources (e.g., frequency and time resources in in an orthogonal frequency-division multiplexing (OFDM) scheme used by 4G and 5G cellular technologies) that may be used for the transmission of RF signals via sidelink for positioning. Each resource pool may further include a particular subcarrier spacing (SCS), cyclic prefix (CP) type, bandwidth (BW) (e.g., subcarriers, bandwidth part, etc.), time-domain location (e.g., periodicity and slot offset) Resource pools may comprise, for example, Tx resource pools for “Mode 1” sidelink positioning in which sidelink positioning is performed using one or more network-connected UEs, in which case network-based resource allocation may be received by a network-connected UE via a Uu interface with a TRP (e.g., via Downlink Control Information (DCI) or Radio Resource Control (RRC)). Tx resource pools for “Mode 2” sidelink positioning in which autonomous resource selection is performed by UEs without network-based resource allocation. Resource pools may further comprise Rx resource pools, which may be used in either Mode 1 or Mode 2 sidelink positioning. Each RP-P configuration may be relayed via a physical sidelink control channel (PSCCH), which may reserve one or more SL-PRS configurations. Each of the one or more SL-PRS configurations of in RP-P may include respective specific physical layer features such as a number of symbols, comb type, comb-offset, number of subchannels, some channel size, and start resource block (RB). The RP-P configuration may further include a sensing configuration, power control, and/or Channel Busy Ratio (CBR). According to some embodiments, exceptional RP-P can be designated and used in circumstances in which it may not be desirable or possible to perform sidelink positioning via the available resource pools of standard RP-P for sidelink.

FIG. 4A-4C are diagrams illustrating how discontinuous reception (DRX) may be implemented within a wireless communication network and/or positioning system (e.g., as described with regard to FIGS. 1-3), according to embodiments. In normal (non-DRX) operation, UE operates in an ON or “awake” to monitor PDCCH for every subframe. Ultimately, this may result the UE operating in the ON state all of the time because is unknown to the UE exactly when the network will transmit the data for it. This can result in high power usage, which is generally undesirable for most UEs.

FIG. 4A illustrates a basic example of how DRX operation can help reduce power consumption. In DRX operation, the UE undergoes periodic DRX cycles 410, each having an ON duration 420 and an OFF duration 430. According to some embodiments, the value of the duration of DRX cycles 410 may not be explicitly specified in RRC messages, but may be calculated (e.g., by subframe time and the value for longdrx_CycleStartOffset, as specified in relevant 3GPP documentation). During the ON duration 420 the UE operates in an ON/awake state in which the UE is capable of monitoring control messages from the network (e.g., PDCCH). Conversely, during the OFF duration 430 the UE operates in an OFF or “sleep” state in which the UE does not monitor control messages from the network. The relatively low power usage during OFF durations 430 results in power savings for the UE during DRX operation.

DRX operation may be governed by different parameters, which may be provided, for example, by the network to the UE in a DRX configuration. An onDurationTimer, for example, may specify the ON duration 420. A drx-Inactivity timer may specify how long UE should in the ON state after the reception of a PDCCH. As shown in FIG. 4B, for example, the drx-Inactivity timer may specify the DRX inactivity duration 440 during which the UE may remain in the ON state after receiving a PDCCH at PDCCH reception time 450. As illustrated, this may extend the ON duration of the respective DRX cycle 410 (extended ON duration 455) into the period in which the UE would otherwise be operating in an OFF state. A drx-Retransmission timer may specify a maximum number of consecutive PDCCH subframes during which the UE should remain in the ON state to wait for an incoming retransmission after a first available retransmission time. A shortDRX-Cycle DRX cycle can be implemented within the OFF duration of a long DRX Cycle, and may be used together with a drxShortCycleTimer, which specifies a consecutive number of subframes the UE may follow the short DRX cycle after the DRX Inactivity Timer has expired, to effectively shorten an on duration. As shown in FIG. 4C, for example, a DRX command Medium Access Control—Control Element (MAC CE) reception time 460 received during the ON state of a DRX cycle may result in a shortened ON duration 470.

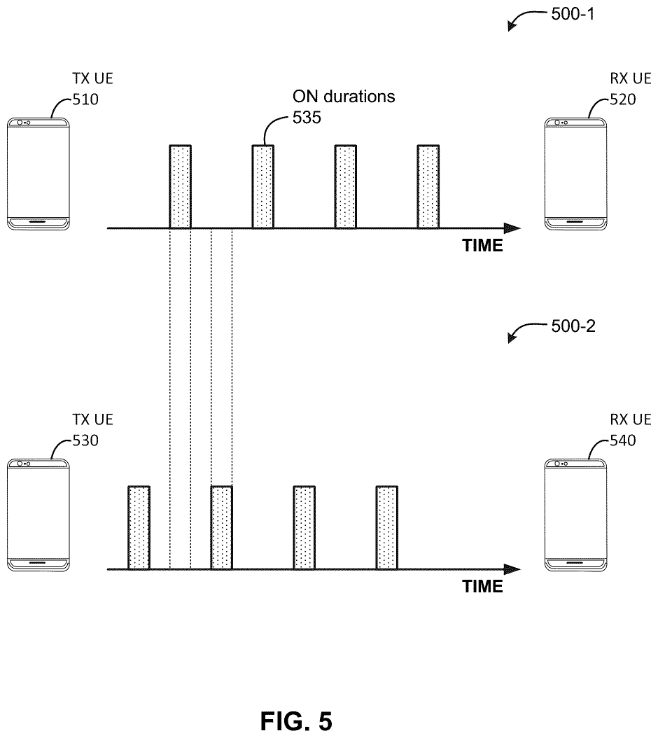

FIG. 5 illustrates how unicast SL DRX operation may be performed between pairs of UEs, according to an embodiment. Here, a first pair 500-1 comprises a TX (transmit) UE 510 and an RX (received) UE 520, and a second pair 500-2 comprises TX UE 530 and RX UE 540. The DRX operation of the first pair 500-1 may be initiated when the TX UE 510 determines a DRX configuration and sends the sends the DRX configuration in a message (e.g., via RRCReconfigurationSidelink) to RX UE 520. In some embodiments, the SL configuration conveying the DRX configuration may also convey the non-DRX configuration. The RX UE 520 can then accept or reject the received DRX configuration in a message (e.g., RRCReconfigurationCompleteSidelink) back to the TX UE 510. Subsequently, during DRX operation, the RX UE 520 monitors time periods during ON durations 535 for control information (e.g., sidelink control information (SCI)) from the TX UE 510. DRX configuration of the second pair 500-2 may follow a similar process as may other DRX configurations between different pairs of UEs, as well as UE/TRP pairs (not shown). A single UE may be paired with multiple UEs and/or TRPs, and may therefore have multiple DRX configurations. As illustrated in FIG. 5, ON durations 535 may be offset in different DRX configurations.

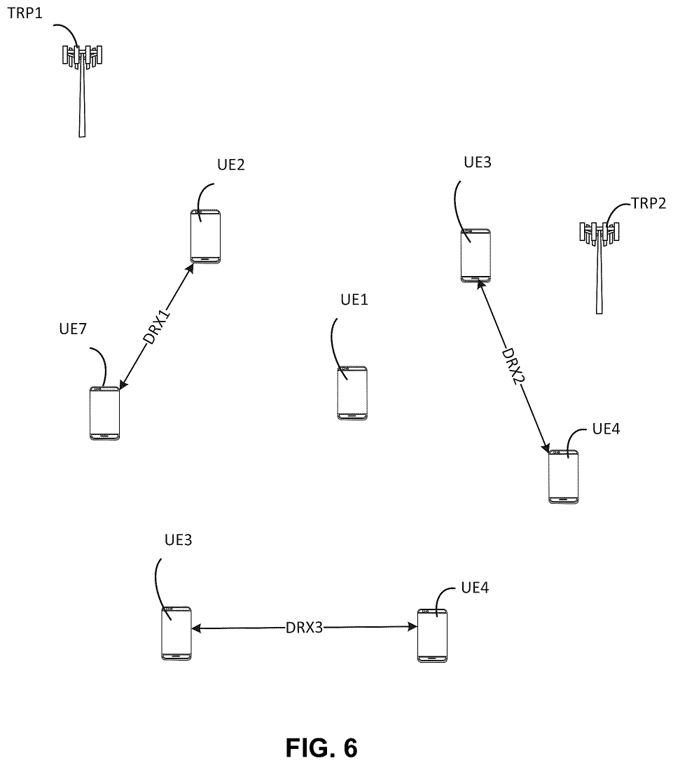

FIG. 6 is an illustration of an example scenario in which DRX may be used to obtain additional anchor points for positioning UE1, a target UE. In this example, UE2, UE3, UE4, UE5, UE6, UE7 are nearby UEs willing to assist as anchor points. DRX pairs (UE2, UE7), (UE3, UE4) and (UE5, UE6) are operating on different DRX configurations (DRX1, DRX2, and DRX3) and each may be connected to different base station and/or may be operating on different resource pool configurations. In this scenario, because UE3, UE4, UE5, UE6, UE7 are operating nearby, UE1 can determine DRX1, DRX2, and DRX3. To determine the location of UE1, UE1 may determine a PRS configuration in view of the nearby DRX configurations. However, because DRX configurations may have offset ON durations UE1 may need to turn on its radio for a longer duration resulting in higher power usage. In other words, UE1 might not get a slot where all the UE TX are active on same time, so PRS resources transmitted by UE1 may need to be distributed over time. This may have the impact on the resource utilization and positioning performance because different pairs of UEs may measure PRS resources transmitted from UE1 in the different time

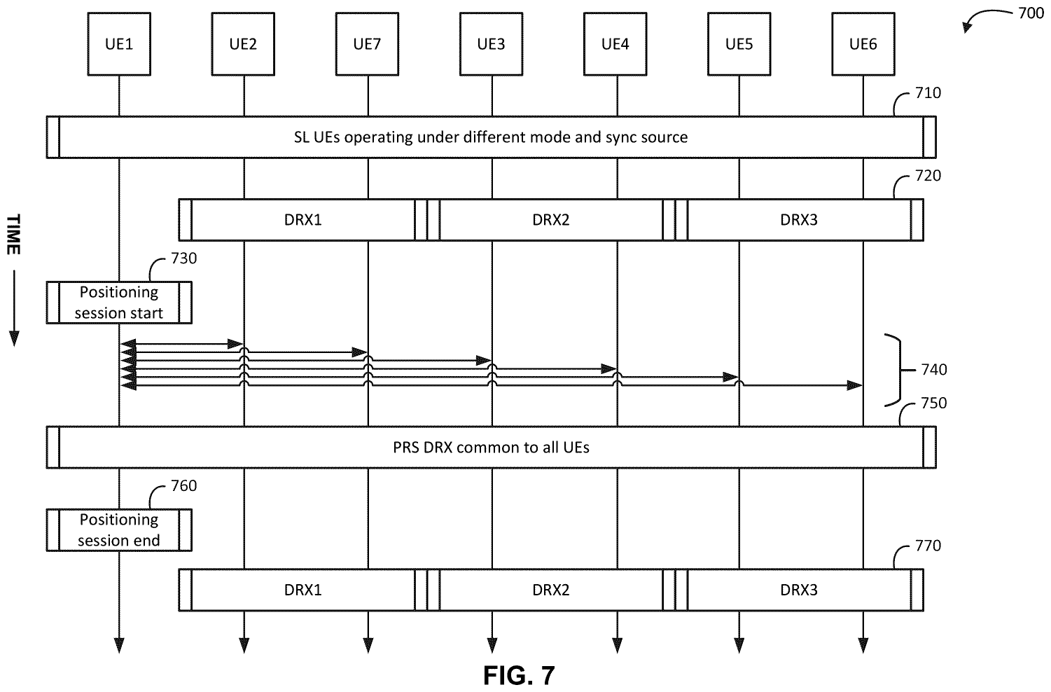

Embodiments herein address these and other issues by implementing one or more PRS DRX configurations associated with positioning, which may be referred to herein as a “PRS DRX configuration,” “SL” PRS DRX configuration,” “SL-DRX positioning configuration” or “SL-DRX for positioning.” FIG. 7 is a call-flow diagram 700 illustrating an example of how an PRS DRX configuration may be used in the scenario of FIG. 6. In this example, UEs 1-7 initially operate under different modes and synchronization sources, as indicated at block 710. As shown by block 720, pairs of UEs may implement different DRX configurations (DRX1, DRX2, and DRX3), as shown in FIG. 6 (e.g., by implementing the DRX configuration exchange previously described with regard to FIG. 5 to set up DRX operation). At block 730, UE1 begins a positioning session in which UE1 is to transmit PRS resources. In response, UE1 may communicate with UE2-UE7, as shown by arrows 740, to communicate PRS configuration information (e.g., when UE1 is scheduled to transmit SL-PRS resources). As described in further detail below, an PRS DRX configuration may be specific to a particular RP-P (or SL-PRS configuration of an RP-P), in which case UE1 may indicate a positioning session ID, SL-PRS configuration identifier, and/or RP-P ID to reference a particular PRS DRX configuration. Additionally or alternatively, UE1 may specify DRX parameters for the PRS DRX configuration. As illustrated at block 750, all UEs may then implement the PRS DRX configuration of the positioning session. By doing so, this can allow UE1 to transmit a single set of SL-PRS resources to all UEs (e.g., in a multicast to UE2-UE7, rather than unicast to each UE separately) to obtain measurements for the positioning session in an efficient manner. The positioning session can then end, as indicated at block 760, after which UE2-UE7 may revert back to the DRX configurations implemented prior to the positioning session, as indicated at block 770.

It can be noted that, according to some embodiments, ON durations within an PRS DRX configurations may allow for additional functionality not typically associated with other types of SL-DRX configurations. For example, for a UE receiving SL-PRS, not only may a UE wake up to monitor SCI that schedule specific SL-PRS during ON durations, but SL-PRS also may be received during these ON durations, according to some embodiments. This can result in additional power savings for UEs.

As noted, according to some embodiments, a PRS DRX configuration may be associated with a RP-P, which may be utilized by UEs during positioning. In such embodiments, a PRS DRX configuration may be specified in an RP-P configuration, and UEs that participate in a positioning session that utilizes the RP-P will operate using the PRS DRX configuration. Put differently, according to an RP-P configuration, UEs participating in a positioning session may be expected to wake up to monitor for SCI that schedule SL-PRS (and/or monitor to receive/measure SL-PRS) inside a RP-P (e.g., only) according to the PRS DRX configuration associated with the RP-P. Thus, in such embodiments, an PRS DRX configuration may be specific to an RP-P rather than a pair of UEs. (E.g., in the example of FIG. 7, the PRS DRX configuration used by all UEs at block 750 may be specific to an RP-P, whereas SL-DRX configurations DRX1, DRX2, and DRX3 may be specific to the pairs of UEs that respectively utilize DRX1, DRX2, and DRX3.)

Additionally or alternatively, according to some embodiments, a PRS DRX configuration may be specific to a particular SL-PRS configuration of an RP-P. That is, one or more SL-PRS configurations may be included in and/or otherwise associated with an RP-P configuration. Therefore, according to some embodiments, UEs participating in a positioning session may be expected to wake up to monitor for SCIs that schedule a specific SL-PRS of a SL-PRS configuration (and/or monitor to receive/measure SL-PRS) inside a RP-P only according to the associated PRS DRX configuration of the SL-PRS configuration. According to some embodiments, if a UE receives an RP-P configuration in which an PRS DRX configuration is not associated with a particular SL-PRS configuration, the PRS DRX configuration may apply to all positioning sessions within the RP-P. In some embodiments, this may indicate a “default” PRS DRX configuration to use if a separate PRS DRX configuration is not specified for a given SL-PRS configuration.

Additionally or alternatively, according to some embodiments, a PRS DRX configuration may be specific to a particular SL positioning session. For example, an SL positioning session may have a unique SL positioning ID which can be associated with one or more RP-Ps and/or one or more SL-PRS configurations. The SL positioning ID may be associated with an PRS DRX configuration. According to some embodiments, information regarding an SL positioning session may be provided to wireless nodes (e.g., UEs and TRPS) participating in a positioning session by an organizing UE, base station, or location server. This information can include, for example, all wireless nodes that are participating, all RP-Ps that are available, PRS configurations inside RP-Ps that can be used, as well as a PRS DRX configuration associated with the positioning session.

Some embodiments may include additional or alternative ways in which an PRS DRX configuration for a positioning session may be provided to a UE. For example, according to some embodiments, a PRS DRX configuration may be configured at application layer of a UE with a mapping between DRX and a specific positioning session (e.g., a unique SL positioning ID). Different applications may be associated with different priority levels such that some applications requiring high-priority and/or low-latency positioning (e.g., emergency calls) may not implement SL-DRX at all, whereas different PRS DRX configurations may be applied to other applications (games, navigation, etc.), depending on the needs of the applications (which may be application-specific). In some embodiments, there may be a maximum (e.g., as designated in a configuration of the UE and/or by UE capability reporting) of PRS DRX configurations at the UE associated with different types of communication characteristics. For example, a UE may be configured to have a maximum of one (or two, three, etc.) PRS DRX configuration associated with a frequency band, licensed/unlicensed frequency usage, FR1/FR2, RP-P, positioning session ID, PRS-configuration, positioning frequency layer (PFL), and/or the like. Additionally or alternatively, according to some embodiments, PRS DRX configurations may be associated with a specific combination of these different characteristics.

UE behavior during a positioning session may vary, depending on the requirements of the positioning session. For example, after a UE transmits a SL-PRS, it may keep monitoring future slots (e.g., outside of DRX ON durations) for SCIs to check when a response message is expected. This may be the case, for instance, when positioning involves 2-way (e.g., “single-sided”) or 3-way (e.g., “double-sided”) RTT measurements. As an example, if a UE transmits a SL-PRS and expects a response message (e.g., for 2-way or 3-way RTT), and if the response has its own reservation procedure, then the first UE may then monitor all SCI occasions for the scheduling of the response, rather than only the ON durations of the PRS DRX configuration. Otherwise, if a response is expected to be received at a specific occasion (e.g., via a common reservation procedure between a transmitted and response message), or if it has been determined (e.g., included in the PRS DRX configuration) that the response shall happen only within the pre-agreed upon DRX ON durations, then the UE may refrain from monitoring subsequent ON durations of the PRS DRX configuration.

A priority associated with certain aspects of the positioning session may also impact UE behavior during the positioning session. For example, for a high priority SL-PRS, Positioning Session, and/or RP-P (e.g., having a priority value above a threshold), a UE that transmits SL-PRS may monitor additional (or all) SCI occasions, which may be independent of the ON durations of PRS DRX configuration used during the positioning session. The UE may further drop other requests for SL transmission (e.g., the UE may not transmit SCI1/SCI2 for some period of time), to help ensure the UE does not miss the SCI being transmitted from a responding UE. To implement this functionality, A UE may have two timers: a first timer tracking a period of time that the UE is guaranteed to only listen for (and not transmit) SCI, and a second timer tracking a period of time during which the UE may be doing Rx or Tx during the SL control symbols.

It can be noted that a UE may implement SL-DRX for data in addition to an SL-DRX for positioning (e.g., PRS DRX). An SL-DRX for positioning and an SL-DRX for data both may be configured to transmit in a slot where both PRS and data can occur (e.g. no dedicated RP-P may exist). In such scenarios, different policies may be established for managing both types of DRX. For example, if an ON duration of the SL-DRX for positioning occurs during an OFF duration of the SL-DRX for data, then the UE may not be expected to monitor for SCIs for data when monitoring for SCIs for positioning. Conversely, if an ON duration of the SL-DRX for data occurs during an OFF duration of the SL-DRX for positioning, then the UE may not be expected to monitor for SCIs for positioning when monitoring for SCIs for data. This functionality may still result in power savings in cases where one of the two purposes (data or positioning) is off. For example, if SCI-1 for positioning is a different size, time (e.g., symbol(s)), frequency, and/or port than SCI-1 for data, the UE may not decode the SCI-1 having the size/time/frequency/port that corresponds to the purpose for which the SL-DRX is OFF. On the other hand, if SCI-1 for both purposes is not distinguishable by size, time, frequency, and/or port, then the UE may need to decode the SCI-1 to determine the purpose. However, if the SCI-1 also points to an SCI-2, then, if the UE is aware that one of the two purposes is OFF (based on the corresponding PRS DRX configurations), the UE may not decode SCI-2 unless (e.g., as determined from the SCI-2 format indicator field in SCI-1) SCI-1 points to an SCI-2 of the same purpose for which the SL-DRX that is ON. Optionally, for instances in which a UE measures and SL-PRS, embodiments may allow the UE to send the measurement report (e.g., via a data payload) in different ways. According to some embodiments, for example, the measurement report may be conveyed by using the SL-DRX for data (e.g., scheduling the payload via SCI transmitted during an ON duration of the SL-DRX for data). Additionally or alternatively, the UE may decide whether the measurement report should override the SL-DRX for data, in which case the UE may keep monitoring for a response (e.g., ignoring ON duration times for SL-DRX for data or positioning) until a report has been received (e.g., up to a maximum length of time).

As noted, one or more PRS DRX configurations may be provided to UEs participating in a positioning session in different ways (e.g., as part of an RP-P configuration, SL-PRS configuration, or positioning session configuration). Depending on desired functionality, these PRS DRX configuration(s) may be provided to these UEs by different devices. For example, according to some embodiments, the PRS DRX configuration(s) may be provided by a location server (e.g., LMF 220 of FIG. 2), a base station (e.g., gNB 210-2 of FIG. 2), and/or by an anchor UE. Moreover, PRS DRX configurations may further be may be dependent on the SL mode (e.g., Mode 1 or Mode 2) in which UEs are operating. With this in mind, different options may include, for example, a configuration source (e.g., location server, base station, or anchor UE) provides PRS DRX configuration(s) that can be used by a SL UE operating mode 1 only, the configuration source provides PRS DRX configuration(s) that can be used by the SL UE operating mode 2 only, and/or the configuration source provides PRS DRX configuration(s) that can be used by the SL UE operating in both mode 1 and mode 2.

According to some embodiments, when setting up a PRS DRX configuration, and initiating UE (e.g., a target or anchor UE) may provide some or all of the possible PRS DRX configuration(s) to other SL UEs participating in the positioning session. (This may occur, for example, in the exchange illustrated by arrows 740 of FIG. 7, in which case UE1 may be the initiating UE.) Each SL UE may respond by providing its preference in the acknowledgment messages. Currently, these acknowledgment messages may comprise RRCReconfigurationCompleteSidelink messages. According to some embodiments, each SL UE may respond by providing a list of possible PRS DRX configurations in order of preference. In some instances, a responding SL UE may also reject all or some of the PRS DRX configurations. For its part, the initiating UE may then review the responses received from the other SL UEs having the PRS DRX configuration priorities and determining a suitable PRS DRX configuration. One means of determination may comprise, for example, selecting a PRS DRX configuration common to all SL UE responses with the highest average priority.

In Mode 1 (having one or more network-connected UEs), the selected PRS DRX configuration may be provided back to the network in different ways, depending on desired functionality. According to one option, for instance, all UEs operating in Mode 1 may provide the selected PRS DRX configuration to a base station (e.g., serving base station) and/or a location server with which they are communicatively connected. According to another option, the initiating UE may provide the selected PRS DRX configuration to a base station (e.g., serving base station) and/or a location server.

According to some embodiments, an PRS DRX configuration may have a timer indicating a window of time during which the PRS DRX configuration is valid. The initiating UE, for example, may set the timer for which the PRS DRX configuration is valid. After the expiry of the timer, participating SL UEs may then revert back to previous SL DRX configuration in which they are operated. (As indicated in the example of FIG. 7, UE2-UE7 reverted to the previous DRX configurations at block 770 after the PRS DRX configuration used at block 750 had expired.)

Embodiments may allow for an PRS DRX configuration to be adjusted in some circumstances. In an example in which UEs have been configured with a common PRS DRX configuration, a special UE (e.g., the initiating UE, a head anchor UE, a road-side unit (RSU) (e.g., for traffic-related applications), an otherwise-designated UE, etc.) may decide to adjust the PRS DRX configuration in one or more ways, such as changing the offset to avoid overlapping with other sidelink DRX ON duration, extending the ON duration due to system loading, adjusting the DRX cycle length due to traffic pattern changes, etc. to do so, the special UE may send a MAC CE to signal the adjustment to the PRS DRX configuration, in which the MAC CE indication may contain fields to indicate various adjustments. For example, fields may indicate an adjustment to the PRS DRX configuration such as offset, ON-duration, DRX cycle length, etc.; an adjustment to the starting time and/or duration for such adjustment; an indication of whether the adjustment is forced (e.g., negotiable or not); if the adjustment is range based (e.g., including the range requirement and the special UE or Tx UE's location); and/or if the indication can be forwarded, and (if so) maximum range or maximum hop number for such forwarding. A receiving UE may decide whether to respond to the special UE's adjustment based on factors such as whether the adjustment is required or negotiable as indicated in the MAC CE; where the receiving UE is located or a distance between the receiving UE and the special UE; and/or the receiving UE's current/alternative sidelink DRX configurations, QoS requirements, and/or or power saving requirements.

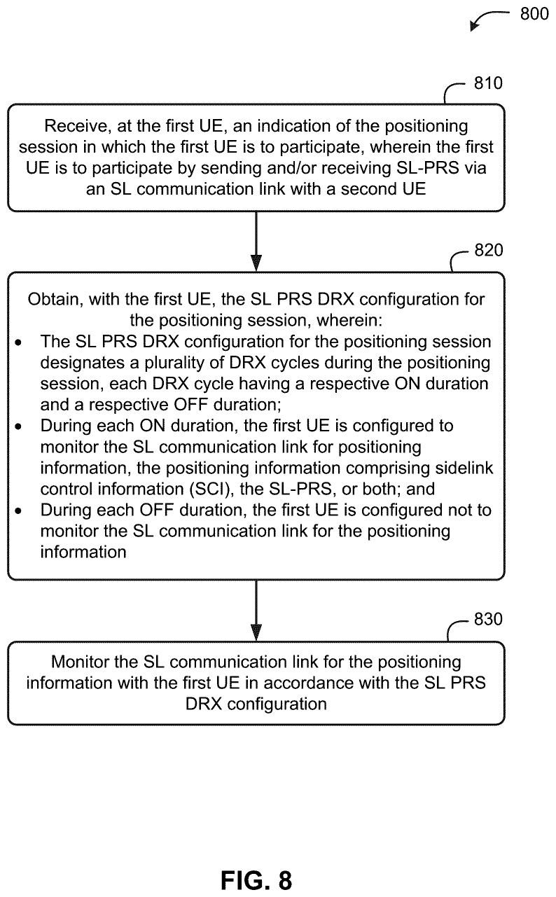

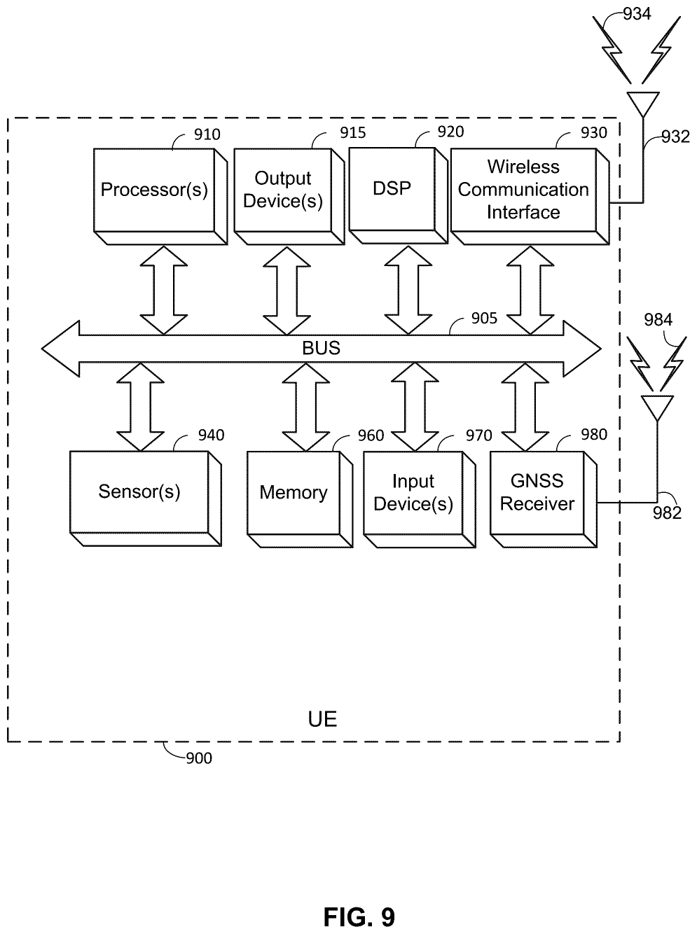

FIG. 8 is a flow diagram of a method 800 implementing an SL PRS DRX configuration for a positioning session at a first UE, according to an embodiment. The method 800 may be implemented by the first UE, which may comprise a target UE or an anchor UE of the positioning session. Means for performing the functionality illustrated in one or more of the blocks shown in FIG. 8 may be performed by hardware and/or software components of a UE. Example components of a UE are illustrated in FIG. 9, which is described in more detail below.

At block 810, the functionality comprises receiving, at the first UE, an indication of the positioning session in which the first UE is to participate, wherein the first UE is to participate by sending and/or receiving SL-PRS via an SL communication link with a second UE. As noted, SL-PRS may be sent or received from a target UE and/or anchor UE during a positioning session. Further, the indication of the positioning session may comprise, for example, a PRS configuration received from a UE (e.g., the second UE), base station (e.g., gNB 210 of FIG. 2), or location server (e.g., LMF 220 of FIG. 2). As noted, a positioning session may occur in either Mode 1 (e.g., in which one or more SL-connected UEs are connected with the network) or Mode 2 (e.g., in which SL-connected UEs are not connected with the network). In Mode 2, for example, the first UE may determine a PRS configuration or receive the PRS configuration from another (e.g., the second) UE.

Means for performing functionality at block 810 may comprise a bus 905, processors 910, digital signal processor (DSP) 920, wireless communication interface 930, memory 960, and/or other components of a UE, as illustrated in FIG. 9, which is described in more detail hereafter.

At block 820, the functionality comprises obtaining, with the first UE, the SL PRS DRX configuration for the positioning session, wherein the SL PRS DRX configuration for the positioning session designates a plurality of DRX cycles during the positioning session, each DRX cycle having a respective ON duration and a respective OFF duration; during each ON duration, the first UE is configured to monitor the SL communication link for positioning information, the positioning information comprising sidelink control information (SCI), the SL-PRS, or both; and during each OFF duration, the first UE is configured not to monitor the SL communication link for the positioning information. As noted in the previously-described embodiments, the SL PRS DRX configuration may be obtained in various ways, such as included in and/or associated with an RP-P configuration, positioning session configuration, or SL PRS configuration. As such, according to some embodiments of the method 800, obtaining the SL PRS DRX configuration for the positioning session may comprise receiving the SL PRS DRX configuration in association with a resource pool for positioning (RP-P). In such embodiments, the SL-PRS may be communicated using resources of the RP-P. According to some embodiments, obtaining the SL PRS DRX configuration for the positioning session may comprise receiving the SL PRS DRX configuration in association with an SL PRS configuration. According to some embodiments, obtaining the SL PRS DRX configuration for the positioning session may comprise receiving the SL PRS DRX configuration in association with the positioning session. As also noted, different SL PRS DRX configurations may be provided to a UE and mapped to various different aspects of the positioning session. As such, according to some embodiments of the method 800, obtaining the SL PRS DRX configuration for the positioning session may comprise determining the SL PRS DRX configuration based on a mapping of the SL PRS DRX with a frequency range used in the positioning session, a frequency band used in the positioning session, a licensed or unlicensed frequency spectrum used in the positioning session, a positioning session ID of the positioning session, or a positioning frequency layer (PFL) of the positioning session, or a combination thereof.

Means for performing functionality at block 820 may comprise a bus 905, processors 910, DSP 920, wireless communication interface 930, memory 960, and/or other components of a UE, as illustrated in FIG. 9, which is described in more detail hereafter.

The functionality at block 830 comprises monitoring the SL communication link for the positioning information with the first UE in accordance with the SL PRS DRX configuration. That is, during each ON duration the first UE may monitor for SCI, the SL-PRS, or both, and during each during each OFF duration the UE may sleep and not monitor for SCI/SL-PRS via the SL communication link.

As indicated in the previously-described embodiments, if the first UE transmits the SL-PRS, it may monitor for a response in different ways. As such, according to some embodiments, the method 800 may further comprise sending the SL-PRS via the SL communication link, and responsive to the sending of the SL-PRS, monitoring the SL communication link for a response to the SL-PRS, wherein the monitoring the SL communication link for the response to the SL-PRS is independent of the ON durations of the plurality of DRX cycles of the SL PRS DRX configuration. The monitoring the SL communication link for the response to the SL-PRS independent of the plurality of DRX cycles of the SL PRS DRX configuration further may be based on the SL-PRS having a priority above a threshold value, or the response to the SL-PRS having a reservation procedure separate from the SL PRS DRX configuration, or a combination thereof. In instances where the SL-PRS has a priority above a threshold value, the monitoring the SL communication link for the response to the SL-PRS may occur over a predetermined period of time. In such instances, the method further comprises refraining from transmitting any wireless signals by the first UE via the SL communication link during the predetermined period of time.

Means for performing functionality at block 830 may comprise a bus 905, processors 910, DSP 920, wireless communication interface 930, memory 960, and/or other components of a UE, as illustrated in FIG. 9, which is described in more detail hereafter.

As described previously, embodiments implement one or more additional features. For example, according to some embodiments, the method 800 may further comprise sending the SL-PRS via the SL communication link, and, subsequent to the sending of the SL-PRS, receiving a response to the SL-PRS via the SL communication link during a first ON duration of the SL PRS DRX configuration. In such instances, the method 800 may further comprise discontinuing the monitoring the SL communication link for the response to the SL-PRS during one or more ON durations of the SL PRS DRX configuration subsequent to the first ON duration. According to some embodiments, the monitoring the SL communication link for the positioning information with the first UE in accordance with the SL PRS DRX configuration may occur during a period of time, in which case, according to some embodiments, the first UE may further operate in accordance with a DRX for data during the period of time. In such embodiments, the first UE may not monitor the SL communication link for the positioning information during an ON duration of the DRX for data. According to some embodiments, obtaining the SL PRS DRX configuration for the positioning session may comprise receiving the SL PRS DRX configuration from a location server, a base station, or the second UE. According to some embodiments, to the method 800 may comprise, prior to receiving the SL PRS DRX configuration, receiving a plurality of available SL PRS DRX configurations from the location server, the base station, or the second UE and sending an indication of a preference of the plurality of available SL PRS DRX configurations to the location server, the base station, or the second UE. The method may further comprise receiving an indication of a period of time during which the SL PRS DRX configuration is to be used. In such embodiments, prior to the monitoring the SL communication link for the positioning information with the first UE in accordance with the SL PRS DRX configuration, the first UE may operate in accordance with a separate SL DRX configuration. In such instances, the method 800 may further comprise operating the first UE in accordance with the separate SL DRX configuration after the period of time.

According to some embodiments of the method 800, adjustments may be made via MAC CE by either the first UE or the second UE. For example, the method 800 may further comprise receiving an indication of an adjustment of the SL PRS DRX configuration from the second UE via a MAC CE. As noted, a receiving UE may respond based on various different factors. As such, such embodiments may further comprise sending a response to the second UE based on an indication of whether the adjustment is required or negotiable, a location or distance of the first UE with respect to the second UE, a SL DRX configuration of the first UE, a Quality of Service (QoS) requirement of the first UE, or a power savings requirement of the first UE, or a combination thereof. Alternatively, if the first UE makes the adjustment to the SL PRS DRX, it may be done by determining an adjustment for the SL PRS DRX configuration and sending an indication of the adjustment to the second UE via a MAC CE.

FIG. 9 is a block diagram of an embodiment of a UE 900, which can be utilized as described herein above (e.g., in association with FIGS. 1-8) an may correspond with UEs 105, 305, 310 510, 520, 530, 540 of FIGS. 1-5, UE1-UE7 of FIGS. 6-7, and/or first and/or second UEs of FIG. 8. For example, the UE 900 can perform one or more of the functions of the method shown in FIG. 8. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 9.

The UE 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as DSP chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The UE 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The UE 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 900 to communicate with other devices as described in the embodiments above. The wireless communication interface 930 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 900 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 900 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the UE 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 910 or DSP 920.

The UE 900 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the UE 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the UE 900 (and/or processor(s) 910 or DSP 920 within UE 900). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method of implementing a sidelink positioning reference signal (SL-PRS) discontinuous reception (DRX) configuration for a positioning session at a first user equipment (UE), the method comprising: receiving, at the first UE, an indication of the positioning session in which the first UE is to participate, wherein the first UE is to participate by sending and/or receiving SL-PRS via a sidelink (SL) communication link with a second UE; obtaining, with the first UE, the SL PRS DRX configuration for the positioning session, wherein: the SL PRS DRX configuration for the positioning session designates a plurality of DRX cycles during the positioning session, each DRX cycle having a respective ON duration and a respective OFF duration; during each ON duration, the first UE is configured to monitor the SL communication link for positioning information, the positioning information comprising sidelink control information (SCI), the SL-PRS, or both; and during each OFF duration, the first UE is configured not to monitor the SL communication link for the positioning information; and monitoring the SL communication link for the positioning information with the first UE in accordance with the SL PRS DRX configuration.

Clause 2. The method of clause 1, wherein: obtaining the SL PRS DRX configuration for the positioning session comprises receiving the SL PRS DRX configuration in association with a resource pool for positioning (RP-P); and the SL-PRS are communicated using resources of the RP-P.

Clause 3. The method of any of clauses 1-2 wherein obtaining the SL PRS DRX configuration for the positioning session comprises receiving the SL PRS DRX configuration in association with an SL PRS configuration.

Clause 4. The method of any of clauses 1-3 wherein obtaining the SL PRS DRX configuration for the positioning session comprises receiving the SL PRS DRX configuration in association with the positioning session.

Clause 5. The method of any of clauses 1-4 wherein obtaining the SL PRS DRX configuration for the positioning session comprises determining the SL PRS DRX configuration based on a mapping of the SL PRS DRX with: a frequency range used in the positioning session, a frequency band used in the positioning session, a licensed or unlicensed frequency spectrum used in the positioning session, a positioning session ID of the positioning session, or a positioning frequency layer (PFL) of the positioning session, or a combination thereof.

Clause 6. The method of any of clauses 1-5 further comprising sending the SL-PRS via the SL communication link; and responsive to the sending of the SL-PRS, monitoring the SL communication link for a response to the SL-PRS, wherein the monitoring the SL communication link for the response to the SL-PRS is independent of the ON durations of the plurality of DRX cycles of the SL PRS DRX configuration.

Clause 7. The method of clause 6 wherein the monitoring the SL communication link for the response to the SL-PRS independent of the plurality of DRX cycles of the SL PRS DRX configuration is further based on: the SL-PRS having a priority above a threshold value, or the response to the SL-PRS having a reservation procedure separate from the SL PRS DRX configuration, or a combination thereof.

Clause 8. The method of clause 7 wherein the SL-PRS has a priority above a threshold value and the monitoring the SL communication link for the response to the SL-PRS occurs over a predetermined period of time, wherein the method further comprises refraining from transmitting any wireless signals by the first UE via the SL communication link during the predetermined period of time.

Clause 9. The method of any of clauses 1-8 further comprising sending the SL-PRS via the SL communication link; subsequent to the sending of the SL-PRS, receiving a response to the SL-PRS via the SL communication link during a first ON duration of the SL PRS DRX configuration; and discontinuing the monitoring the SL communication link for the response to the SL-PRS during one or more ON durations of the SL PRS DRX configuration subsequent to the first ON duration.

Clause 10. The method of any of clauses 1-9 wherein the monitoring the SL communication link for the positioning information with the first UE in accordance with the SL PRS DRX configuration occurs during a period of time, and wherein the first UE further operates in accordance with a DRX for data during the period of time.

Clause 11. The method of clause 10 wherein the first UE does not monitor the SL communication link for the positioning information during an ON duration of the DRX for data.

Clause 12. The method of any of clauses 1-11 wherein obtaining the SL PRS DRX configuration for the positioning session comprises receiving the SL PRS DRX configuration from a location server, a base station, or the second UE.

Clause 13. The method of clause 12 further comprising, prior to receiving the SL PRS DRX configuration receiving a plurality of available SL PRS DRX configurations from the location server, the base station, or the second UE; and sending an indication of a preference of the plurality of available SL PRS DRX configurations to the location server, the base station, or the second UE.

Clause 14. The method of any of clauses 12-13 further comprising receiving an indication of a period of time during which the SL PRS DRX configuration is to be used.

Clause 15. The method of any clause 14 wherein, prior to the monitoring the SL communication link for the positioning information with the first UE in accordance with the SL PRS DRX configuration, the first UE operates in accordance with a separate SL DRX configuration, and wherein the method further comprises operating the first UE in accordance with the separate SL DRX configuration after the period of time.

Clause 16. The method of any of clauses 1-15 further comprising receiving an indication of an adjustment of the SL PRS DRX configuration from the second UE via a Medium Access Control—Control Element (MAC CE); and sending a response to the second UE based on: an indication of whether the adjustment is required or negotiable, a location or distance of the first UE with respect to the second UE, a SL DRX configuration of the first UE, a Quality of Service (QoS) requirement of the first UE, or a power savings requirement of the first UE, or a combination thereof.

Clause 17. The method of any of clauses 1-16 further comprising determining an adjustment for the SL PRS DRX configuration; and sending an indication of the adjustment to the second UE via a MAC CE.

Clause 18. A first user equipment (UE) for implementing a sidelink positioning reference signal (SL-PRS) discontinuous reception (DRX) configuration for a positioning session, the first UE comprising: a transceiver; a memory; and one or more processors communicatively coupled with the transceiver and the memory, wherein the one or more processors are configured to: receive, via the transceiver, an indication of the positioning session in which the first UE is to participate, wherein the first UE is to participate by sending and/or receiving SL-PRS via a sidelink (SL) communication link with a second UE; obtain, via the transceiver, the SL PRS DRX configuration for the positioning session, wherein: the SL PRS DRX configuration for the positioning session designates a plurality of DRX cycles during the positioning session, each DRX cycle having a respective ON duration and a respective OFF duration; during each ON duration, the first UE is configured to monitor the SL communication link for positioning information, the positioning information comprising sidelink control information (SCI), the SL-PRS, or both; and during each OFF duration, the first UE is configured not to monitor the SL communication link for the positioning information; and monitor the SL communication link for the positioning information with the first UE in accordance with the SL PRS DRX configuration.

Clause 19. The first UE of clause 18, wherein: to obtain the SL PRS DRX configuration for the positioning session, the one or more processors are configured to receive the SL PRS DRX configuration in association with a resource pool for positioning (RP-P); and the one or more processors are configured to communicate the SL-PRS using resources of the RP-P.

Clause 20. The first UE of any of clauses 18-19 wherein, to obtain the SL PRS DRX configuration for the positioning session, the one or more processors are configured to receive the SL PRS DRX configuration in association with an SL PRS configuration or the positioning session.

Clause 21. The first UE of any of clauses 18-20 wherein, to obtain the SL PRS DRX configuration for the positioning session, the one or more processors are configured to determine the SL PRS DRX configuration based on a mapping of the SL PRS DRX with a frequency range used in the positioning session, a frequency band used in the positioning session, a licensed or unlicensed frequency spectrum used in the positioning session, a positioning session ID of the positioning session, or a positioning frequency layer (PFL) of the positioning session, or a combination thereof.

Clause 22. The first UE of any of clauses 18-21 wherein the one or more processors are further configured to: send the SL-PRS via the SL communication link; and responsive to the sending of the SL-PRS, monitor the SL communication link for a response to the SL-PRS, wherein the one or more processors are configured to monitor the SL communication link for the response to the SL-PRS independently of the ON durations of the plurality of DRX cycles of the SL PRS DRX configuration.

Clause 23. The first UE of clause 22 wherein the monitoring the SL communication link for the response to the SL-PRS independent of the plurality of DRX cycles of the SL PRS DRX configuration is further based on: the SL-PRS having a priority above a threshold value, or the response to the SL-PRS having a reservation procedure separate from the SL PRS DRX configuration, or a combination thereof.

Clause 24. The first UE of clause 23 wherein the one or more processors are configured to refrain from transmitting any wireless signals via the SL communication link during a predetermined period of time when the SL-PRS has a priority above a threshold value and the one or more processors are configured to monitor the SL communication link for the response to the SL-PRS occurs over the predetermined period of time.

Clause 25. The first UE of any of clauses 18-24 wherein the one or more processors are further configured to: send the SL-PRS via the SL communication link; subsequent to the sending of the SL-PRS, receive a response to the SL-PRS via the SL communication link during a first ON duration of the SL PRS DRX configuration; and discontinue the monitoring the SL communication link for the response to the SL-PRS during one or more ON durations of the SL PRS DRX configuration subsequent to the first ON duration.

Clause 26. The first UE of any of clauses 18-25 wherein the one or more processors are configured to perform the monitoring of the SL communication link for the positioning information with the first UE in accordance with the SL PRS DRX configuration during a period of time, and wherein the one or more processors are configured to operate the UE in accordance with a DRX for data during the period of time.

Clause 27. The first UE of clause 26 wherein the one or more processors are configured to refrain from monitoring the SL communication link for the positioning information during an ON duration of the DRX for data.

Clause 28. The first UE of any of clauses 18-27 wherein, to obtain the SL PRS DRX configuration for the positioning session, the one or more processors are configured to receive the SL PRS DRX configuration from a location server, a base station, or the second UE.

Clause 29. The first UE of clause 28 wherein the one or more processors are further configured to, prior to receiving the SL PRS DRX configuration: receive, via the transceiver, a plurality of available SL PRS DRX configurations from the location server, the base station, or the second UE; and send, via the transceiver, an indication of a preference of the plurality of available SL PRS DRX configurations to the location server, the base station, or the second UE.

Clause 30. The first UE of any of clauses 28-29 wherein the one or more processors are further configured to receive an indication of a period of time during which the SL PRS DRX configuration is to be used.

Clause 31. The first UE of clause 30 wherein, prior to the monitoring the SL communication link for the positioning information with the first UE in accordance with the SL PRS DRX configuration, the one or more processors are configured to operate the first UE in accordance with a separate SL DRX configuration, and wherein the one or more processors are further configured to operate the first UE in accordance with the separate SL DRX configuration after the period of time.

Clause 32. The first UE of any of clauses 18-31 wherein the one or more processors are further configured to: receive, via the transceiver, an indication of an adjustment of the SL PRS DRX configuration from the second UE via a Medium Access Control—Control Element (MAC CE); and send, via the transceiver, a response to the second UE based on: an indication of whether the adjustment is required or negotiable, a location or distance of the first UE with respect to the second UE, a SL DRX configuration of the first UE, a Quality of Service (QoS) requirement of the first UE, or a power savings requirement of the first UE, or a combination thereof.

Clause 33. The first UE of any of clauses 18-32 wherein the one or more processors are further configured to: determine an adjustment for the SL PRS DRX configuration; and send an indication of the adjustment to the second UE via a MAC CE.

Clause 34. An apparatus for implementing a sidelink positioning reference signal (SL-PRS) discontinuous reception (DRX) configuration for a positioning session at a first user equipment (UE), the apparatus comprising: means for receiving an indication of the positioning session in which the first UE is to participate, wherein the first UE is to participate by sending and/or receiving SL-PRS via a sidelink (SL) communication link with a second UE; means for obtaining the SL PRS DRX configuration for the positioning session, wherein: the SL PRS DRX configuration for the positioning session designates a plurality of DRX cycles during the positioning session, each DRX cycle having a respective ON duration and a respective OFF duration; during each ON duration, the first UE is configured to monitor the SL communication link for positioning information, the positioning information comprising sidelink control information (SCI), the SL-PRS, or both; and during each OFF duration, the first UE is configured not to monitor the SL communication link for the positioning information; and means for monitoring the SL communication link for the positioning information with the first UE in accordance with the SL PRS DRX configuration.

Clause 35. The apparatus of clause 34, wherein: the means for obtaining the SL PRS DRX configuration for the positioning session comprises means for receiving the SL PRS DRX configuration in association with a resource pool for positioning (RP-P); and the SL-PRS are communicated using resources of the RP-P.

Clause 36. The apparatus of any of clauses 34-35 wherein the means for obtaining the SL PRS DRX configuration for the positioning session comprises means for receiving the SL PRS DRX configuration in association with an SL PRS configuration or the positioning session.

Clause 37. The apparatus of any of clauses 34-36 wherein the means for obtaining the SL PRS DRX configuration for the positioning session comprises means for determining the SL PRS DRX configuration based on a mapping of the SL PRS DRX with: a frequency range used in the positioning session, a frequency band used in the positioning session, a licensed or unlicensed frequency spectrum used in the positioning session, a positioning session ID of the positioning session, or a positioning frequency layer (PFL) of the positioning session, or a combination thereof.

Clause 38. The apparatus of any of clauses 34-37 further comprising means for sending the SL-PRS via the SL communication link; and means for, responsive to the sending of the SL-PRS, monitoring the SL communication link for a response to the SL-PRS, wherein the monitoring the SL communication link for the response to the SL-PRS is independent of the ON durations of the plurality of DRX cycles of the SL PRS DRX configuration.

Clause 39. The apparatus of any of clauses 34-38 further comprising means for sending the SL-PRS via the SL communication link; means for, subsequent to the sending of the SL-PRS, receiving a response to the SL-PRS via the SL communication link during a first ON duration of the SL PRS DRX configuration; and means for discontinuing the monitoring the SL communication link for the response to the SL-PRS during one or more ON durations of the SL PRS DRX configuration subsequent to the first ON duration.

Clause 40. A non-transitory computer-readable medium storing instructions for implementing a sidelink positioning reference signal (SL-PRS) discontinuous reception (DRX) configuration for a positioning session at a first user equipment (UE), the instructions comprising code for: receiving, at the first UE, an indication of the positioning session in which the first UE is to participate, wherein the first UE is to participate by sending and/or receiving SL-PRS via a sidelink (SL) communication link with a second UE; obtaining, with the first UE, the SL PRS DRX configuration for the positioning session, wherein: the SL PRS DRX configuration for the positioning session designates a plurality of DRX cycles during the positioning session, each DRX cycle having a respective ON duration and a respective OFF duration; during each ON duration, the first UE is configured to monitor the SL communication link for positioning information, the positioning information comprising sidelink control information (SCI), the SL-PRS, or both; and during each OFF duration, the first UE is configured not to monitor the SL communication link for the positioning information; and monitoring the SL communication link for the positioning information with the first UE in accordance with the SL PRS DRX configuration.

What is claimed is:

1. A method of implementing a sidelink positioning reference signal (SL-PRS) discontinuous reception (DRX) configuration for a positioning session at a first user equipment (UE), the method comprising:
receiving, at the first UE, an indication of the positioning session in which the first UE is to participate, wherein the first UE is to participate by sending and/or receiving SL-PRS via a sidelink (SL) communication link with a second UE;
obtaining, with the first UE, the SL PRS DRX configuration for the positioning session, wherein:
the SL PRS DRX configuration for the positioning session designates a plurality of DRX cycles during the positioning session, each DRX cycle having a respective ON duration and a respective OFF duration;
during each ON duration, the first UE is configured to monitor the SL communication link for positioning information, the positioning information comprising sidelink control information (SCI), the SL-PRS, or both; and
during each OFF duration, the first UE is configured not to monitor the SL communication link for the positioning information; and
monitoring the SL communication link for the positioning information with the first UE in accordance with the SL PRS DRX configuration.

2. The method of claim 1, wherein:
obtaining the SL PRS DRX configuration for the positioning session comprises receiving the SL PRS DRX configuration in association with a resource pool for positioning (RP-P); and
the SL-PRS are communicated using resources of the RP-P.

3. The method of claim 1, wherein obtaining the SL PRS DRX configuration for the positioning session comprises receiving the SL PRS DRX configuration in association with an SL PRS configuration.

4. The method of claim 1, wherein obtaining the SL PRS DRX configuration for the positioning session comprises receiving the SL PRS DRX configuration in association with the positioning session.

5. The method of claim 1, wherein obtaining the SL PRS DRX configuration for the positioning session comprises determining the SL PRS DRX configuration based on a mapping of the SL PRS DRX with:
a frequency range used in the positioning session,
a frequency band used in the positioning session,
a licensed or unlicensed frequency spectrum used in the positioning session,
a positioning session ID of the positioning session, or
a positioning frequency layer (PFL) of the positioning session, or
a combination thereof.

6. The method of claim 1, further comprising:
sending the SL-PRS via the SL communication link; and
responsive to the sending of the SL-PRS, monitoring the SL communication link for a response to the SL-PRS, wherein the monitoring the SL communication link for the response to the SL-PRS is independent of the ON durations of the plurality of DRX cycles of the SL PRS DRX configuration.

7. The method of claim 6, wherein the monitoring the SL communication link for the response to the SL-PRS independent of the plurality of DRX cycles of the SL PRS DRX configuration is further based on:
the SL-PRS having a priority above a threshold value, or
the response to the SL-PRS having a reservation procedure separate from the SL PRS DRX configuration, or
a combination thereof.

8. The method of claim 7, wherein the SL-PRS has a priority above a threshold value and the monitoring the SL communication link for the response to the SL-PRS occurs over a predetermined period of time, wherein the method further comprises refraining from transmitting any wireless signals by the first UE via the SL communication link during the predetermined period of time.

9. The method of claim 1, further comprising:
sending the SL-PRS via the SL communication link;
subsequent to the sending of the SL-PRS, receiving a response to the SL-PRS via the SL communication link during a first ON duration of the SL PRS DRX configuration; and
discontinuing the monitoring the SL communication link for the response to the SL-PRS during one or more ON durations of the SL PRS DRX configuration subsequent to the first ON duration.

10. The method of claim 1, wherein the monitoring the SL communication link for the positioning information with the first UE in accordance with the SL PRS DRX configuration occurs during a period of time, and wherein the first UE further operates in accordance with a DRX for data during the period of time.

11. The method of claim 10, wherein the first UE does not monitor the SL communication link for the positioning information during an ON duration of the DRX for data.

12. The method of claim 1, wherein obtaining the SL PRS DRX configuration for the positioning session comprises receiving the SL PRS DRX configuration from a location server, a base station, or the second UE.

13. The method of claim 12, further comprising, prior to receiving the SL PRS DRX configuration:
receiving a plurality of available SL PRS DRX configurations from the location server, the base station, or the second UE; and
sending an indication of a preference of the plurality of available SL PRS DRX configurations to the location server, the base station, or the second UE.

14. The method of claim 12, further comprising receiving an indication of a period of time during which the SL PRS DRX configuration is to be used.

15. The method of claim 14, wherein, prior to the monitoring the SL communication link for the positioning information with the first UE in accordance with the SL PRS DRX configuration, the first UE operates in accordance with a separate SL DRX configuration, and wherein the method further comprises operating the first UE in accordance with the separate SL DRX configuration after the period of time.

16. The method of claim 1, further comprising:
receiving an indication of an adjustment of the SL PRS DRX configuration from the second UE via a Medium Access Control—Control Element (MAC CE); and
sending a response to the second UE based on:
an indication of whether the adjustment is required or negotiable,
a location or distance of the first UE with respect to the second UE,
a SL DRX configuration of the first UE,
a Quality of Service (QoS) requirement of the first UE, or
a power savings requirement of the first UE, or
a combination thereof.

17. The method of claim 1, further comprising:
determining an adjustment for the SL PRS DRX configuration; and
sending an indication of the adjustment to the second UE via a MAC CE.

18. A first user equipment (UE) for implementing a sidelink positioning reference signal (SL-PRS) discontinuous reception (DRX) configuration for a positioning session, the first UE comprising:
a transceiver;
a memory; and
one or more processors communicatively coupled with the transceiver and the memory, wherein the one or more processors are configured to:
receive, via the transceiver, an indication of the positioning session in which the first UE is to participate, wherein the first UE is to participate by sending and/or receiving SL-PRS via a sidelink (SL) communication link with a second UE;
obtain, via the transceiver, the SL PRS DRX configuration for the positioning session, wherein:
the SL PRS DRX configuration for the positioning session designates a plurality of DRX cycles during the positioning session, each DRX cycle having a respective ON duration and a respective OFF duration;
during each ON duration, the first UE is configured to monitor the SL communication link for positioning information, the positioning information comprising sidelink control information (SCI), the SL-PRS, or both; and
during each OFF duration, the first UE is configured not to monitor the SL communication link for the positioning information; and
monitor the SL communication link for the positioning information with the first UE in accordance with the SL PRS DRX configuration.

19. The first UE of claim 18, wherein:
to obtain the SL PRS DRX configuration for the positioning session, the one or more processors are configured to receive the SL PRS DRX configuration in association with a resource pool for positioning (RP-P); and
the one or more processors are configured to communicate the SL-PRS using resources of the RP-P.

20. The first UE of claim 18, wherein, to obtain the SL PRS DRX configuration for the positioning session, the one or more processors are configured to receive the SL PRS DRX configuration in association with an SL PRS configuration or the positioning session.

21. The first UE of claim 18, wherein, to obtain the SL PRS DRX configuration for the positioning session, the one or more processors are configured to determine the SL PRS DRX configuration based on a mapping of the SL PRS DRX with:
a frequency range used in the positioning session,
a frequency band used in the positioning session,
a licensed or unlicensed frequency spectrum used in the positioning session,
a positioning session ID of the positioning session, or
a positioning frequency layer (PFL) of the positioning session, or
a combination thereof.

22. The first UE of claim 18, wherein the one or more processors are further configured to:
send the SL-PRS via the SL communication link; and
responsive to the sending of the SL-PRS, monitor the SL communication link for a response to the SL-PRS, wherein the one or more processors are configured to monitor the SL communication link for the response to the SL-PRS independently of the ON durations of the plurality of DRX cycles of the SL PRS DRX configuration.

23. The first UE of claim 22, wherein the monitoring the SL communication link for the response to the SL-PRS independent of the plurality of DRX cycles of the SL PRS DRX configuration is further based on:
the SL-PRS having a priority above a threshold value, or
the response to the SL-PRS having a reservation procedure separate from the SL PRS DRX configuration, or
a combination thereof.

24. The first UE of claim 23, wherein the one or more processors are configured to refrain from transmitting any wireless signals via the SL communication link during a predetermined period of time when the SL-PRS has a priority above a threshold value and the one or more processors are configured to monitor the SL communication link for the response to the SL-PRS occurs over the predetermined period of time.

25. The first UE of claim 18, wherein the one or more processors are further configured to:
send the SL-PRS via the SL communication link;
subsequent to the sending of the SL-PRS, receive a response to the SL-PRS via the SL communication link during a first ON duration of the SL PRS DRX configuration; and
discontinue the monitoring the SL communication link for the response to the SL-PRS during one or more ON durations of the SL PRS DRX configuration subsequent to the first ON duration.

26. The first UE of claim 18, wherein the one or more processors are configured to perform the monitoring of the SL communication link for the positioning information with the first UE in accordance with the SL PRS DRX configuration during a period of time, and wherein the one or more processors are configured to operate the UE in accordance with a DRX for data during the period of time.

27. The first UE of claim 26, wherein the one or more processors are configured to refrain from monitoring the SL communication link for the positioning information during an ON duration of the DRX for data.

28. The first UE of claim 18, wherein, to obtain the SL PRS DRX configuration for the positioning session, the one or more processors are configured to receive the SL PRS DRX configuration from a location server, a base station, or the second UE.

29. The first UE of claim 28, wherein the one or more processors are further configured to, prior to receiving the SL PRS DRX configuration:
receive, via the transceiver, a plurality of available SL PRS DRX configurations from the location server, the base station, or the second UE; and
send, via the transceiver, an indication of a preference of the plurality of available SL PRS DRX configurations to the location server, the base station, or the second UE.

30. The first UE of claim 28, wherein the one or more processors are further configured to receive an indication of a period of time during which the SL PRS DRX configuration is to be used.

31. The first UE of claim 30, wherein, prior to the monitoring the SL communication link for the positioning information with the first UE in accordance with the SL PRS DRX configuration, the one or more processors are configured to operate the first UE in accordance with a separate SL DRX configuration, and wherein the one or more processors are further configured to operate the first UE in accordance with the separate SL DRX configuration after the period of time.

32. The first UE of claim 18, wherein the one or more processors are further configured to:
receive, via the transceiver, an indication of an adjustment of the SL PRS DRX configuration from the second UE via a Medium Access Control—Control Element (MAC CE); and
send, via the transceiver, a response to the second UE based on:
an indication of whether the adjustment is required or negotiable,
a location or distance of the first UE with respect to the second UE,
a SL DRX configuration of the first UE,
a Quality of Service (QoS) requirement of the first UE, or
a power savings requirement of the first UE, or
a combination thereof.

33. The first UE of claim 18, wherein the one or more processors are further configured to:
determine an adjustment for the SL PRS DRX configuration; and
send an indication of the adjustment to the second UE via a MAC CE.

34. An apparatus for implementing a sidelink positioning reference signal (SL-PRS) discontinuous reception (DRX) configuration for a positioning session at a first user equipment (UE), the apparatus comprising:
means for receiving an indication of the positioning session in which the first UE is to participate, wherein the first UE is to participate by sending and/or receiving SL-PRS via a sidelink (SL) communication link with a second UE;
means for obtaining the SL PRS DRX configuration for the positioning session, wherein:
the SL PRS DRX configuration for the positioning session designates a plurality of DRX cycles during the positioning session, each DRX cycle having a respective ON duration and a respective OFF duration;
during each ON duration, the first UE is configured to monitor the SL communication link for positioning information, the positioning information comprising sidelink control information (SCI), the SL-PRS, or both; and
during each OFF duration, the first UE is configured not to monitor the SL communication link for the positioning information; and
means for monitoring the SL communication link for the positioning information with the first UE in accordance with the SL PRS DRX configuration.

35. The apparatus of claim 34, wherein:
the means for obtaining the SL PRS DRX configuration for the positioning session comprises means for receiving the SL PRS DRX configuration in association with a resource pool for positioning (RP-P); and
the SL-PRS are communicated using resources of the RP-P.

36. The apparatus of claim 34, wherein the means for obtaining the SL PRS DRX configuration for the positioning session comprises means for receiving the SL PRS DRX configuration in association with an SL PRS configuration or the positioning session.

37. The apparatus of claim 34, wherein the means for obtaining the SL PRS DRX configuration for the positioning session comprises means for determining the SL PRS DRX configuration based on a mapping of the SL PRS DRX with:
a frequency range used in the positioning session,
a frequency band used in the positioning session,
a licensed or unlicensed frequency spectrum used in the positioning session,
a positioning session ID of the positioning session, or
a positioning frequency layer (PFL) of the positioning session, or a combination thereof.

38. The apparatus of claim 34, further comprising:
means for sending the SL-PRS via the SL communication link; and
means for, responsive to the sending of the SL-PRS, monitoring the SL communication link for a response to the SL-PRS, wherein the monitoring the SL communication link for the response to the SL-PRS is independent of the ON durations of the plurality of DRX cycles of the SL PRS DRX configuration.

39. The apparatus of claim 34, further comprising:
means for sending the SL-PRS via the SL communication link;
means for, subsequent to the sending of the SL-PRS, receiving a response to the SL-PRS via the SL communication link during a first ON duration of the SL PRS DRX configuration; and
means for discontinuing the monitoring the SL communication link for the response to the SL-PRS during one or more ON durations of the SL PRS DRX configuration subsequent to the first ON duration.

40. A non-transitory computer-readable medium storing instructions for implementing a sidelink positioning reference signal (SL-PRS) discontinuous reception (DRX) configuration for a positioning session at a first user equipment (UE), the instructions comprising code for:
receiving, at the first UE, an indication of the positioning session in which the first UE is to participate, wherein the first UE is to participate by sending and/or receiving SL-PRS via a sidelink (SL) communication link with a second UE;
obtaining, with the first UE, the SL PRS DRX configuration for the positioning session, wherein:
the SL PRS DRX configuration for the positioning session designates a plurality of DRX cycles during the positioning session, each DRX cycle having a respective ON duration and a respective OFF duration;
during each ON duration, the first UE is configured to monitor the SL communication link for positioning information, the positioning information comprising sidelink control information (SCI), the SL-PRS, or both; and
during each OFF duration, the first UE is configured not to monitor the SL communication link for the positioning information; and
monitoring the SL communication link for the positioning information with the first UE in accordance with the SL PRS DRX configuration.
